(19) United States
(12) Patent Application Publication
(10) Pub. No.: US 2010/0174791 A1
(43) Pub. Date: Jul. 8, 2010

(54) SHORT DISTANCE WIRELESS COMMUNICATION SYSTEM AND METHOD FOR ACCESSING INSTANT MESSENGER

(75) Inventors: Dan Tian, Beijing (CN); Lei Zhao, Beijing (CN); Haifeng Yang, Beijing (CN)

Correspondence Address: CONNOLLY BOVE LODGE & HUTZ, LLP, P O BOX 2207, WILMINGTON, DE, 19899, US

(73) Assignee: IVT (Beijing) Software Technology Inc., Beijing (CN)

(21) Appl. No.: 12/376,845

(22) PCT Filed: Aug. 10, 2007
(86) PCT No.: PCT/CN07/02401

§ 371 Date: Feb. 9, 2009

(30) Foreign Application Priority Data
Aug. 11, 2006 (CN) 200610109790.2

(51) Int. Cl. G06F 15/16; H04B 7/00

(52) U.S. Cl. 709/206; 455/41.2

(57) ABSTRACT

The present invention discloses an access system and an access method that enable a wireless slim terminal device accessing to at least one instant messenger (IM). The access system consists of a wireless slim terminal device and a wireless access point. The wireless slim terminal device notifies the wireless access point the type of a desired IM to be accessed and an associated instant message user identifier, the wireless access point accesses to the IM with the instant message user identifier so as to enable the wireless slim terminal to communicate with a remote terminal device.

### BACKGROUND OF THE INVENTION

1. Field of the Invention

The present invention relates to instant messaging technology, in particular to a short distance wireless communication system and method for accessing to an instant messenger.

2. Description of the Related Art

At present, PC-based and Internet-based communication tools are mainly Instant Messengers IMs, such as MSN, QQ, Skype and the likes, which have been extensively applied and accepted by virtue of their instant on-line character and rich features. For example, a user can accomplish various kinds of operations via Internet instant messaging service, such as transmitting and receiving information, transferring file, dialing voice/video phone, etc., in a convenient and efficient way. According to the current manner of using an IM, a user commonly communicates via PC, using keyboard to input, finding out the result via computer screen and dialing voice phone with earphone and microphone, however, such manner restricts the user before the computer and is still somewhat inconvenient in relative to telephone communication using telephone or mobile phone. Furthermore, if the user fails to notice the IM operating on the PC constantly, he/she will be impossible to timely learn the instant message information sent from a remote user. In addition, there are many IMs in present Internet, a user usually needs to install several different IMs simultaneously, which is a very complicated task to normal users.

One of the current solutions is connecting a telephone to computer as a voice input/output and simple keyboard operation input to cooperate with the application of a certain IM on the computer. The specification of Chinese patent CN 1489368A has disclosed such a method and system for integrating a telephone into an instant message tool, wherein the telephone is connected to a computer via a USB interface, an instant message client program on the computer receives an instruction from the telephone and establishes a voice information channel between the instant message users to make voice communication between the users. Such method integrates telephone into the IM as a voice and control terminal of instant message and is easy to operate. However, the telephone is wiredly connected to the computer, furthermore, the telephone has limited control function for it is unable to inter-communicate messages and files with the IM.

Another solution is to install an instant message client program into a computer and make the wireless user terminal serve as an input/output of instant message voice and a keyboard to cooperate with the application of TM. For example, TVP-SP1BK produced by TRENDnet accomplishes this solution. This product has a mobile phone interface, adopts Bluetooth short distance wireless technology to control Skype on the computer and can realize the functions of synchronizing phone book, dialing/receiving telephone, etc. However, it needs the user to firstly log in Skype on computer during use. Although this product can be applied to other IMs such as MSN as well, it only serves as Bluetooth wireless earphone and microphone in these systems, but fails to really support all relevant functions of the instant messenger, that is, this product cannot perform transmission of information, such as message, file, voice and video.

A further solution is to directly install an instant message client program on a wireless user terminal, for instance, a smart phone, therefore an IP network is supported via long distance wireless communication technology such as GPRS, GSM, etc., that is, the IM communication is directly realized by the instant message client program on the wireless client terminal through the IP network connection. This solution has a high demand for wireless user terminal configuration and requires the wireless user terminal to update irregularly following the version upgrade of the IM, and meanwhile, the communication cost of the mobile IP communication network is relatively high.

Among the existing solutions, however, the user terminals are accessible to only one kind of IM but still not accessible to multiple different kinds of IMs simultaneously.

### SUMMARY OF THE INVENTION

Therefore, the technical problem to be solved by the present invention is to provide an access system and an access method that enable a wireless slim terminal device to access at least one kind of Instant Messenger (IM).

According to the present invention, an access method for enabling a wireless slim terminal device accessing to at least one kind of IM via a wireless access point is provided, the wireless access point being able to connect with one or more kinds of 1Ms and communicate with various IMs in compliance with different communication protocols through the IP network connected thereto. This wireless access point can perform translation of command and data between various kinds of IM protocols and the short distance wireless communication protocol supported by the wireless access point and wireless slim terminal device. The wireless slim terminal device stores an instant message user identifier and relevant information of at least one kind of IM, and connects with the wireless access point by short distance wireless communication technology (mainly including Bluetooth, WiFi, UWB and wireless USB). The wireless slim terminal device transmits the instant message user identifier of the at least one kind of IM to the wireless access point, the wireless access point automatically logs in the corresponding IM according to the instant message user identifier, so as to enable the wireless slim terminal device to communicate with the server and remote terminal device of one or more kinds of IMs via the wireless access point. Specifically, the wireless slim terminal device communicates with the server and remote terminal device of the IM via the wireless access point, comprising the steps of:

(a) establishing a short distance wireless connection with a wireless access point by a wireless slim terminal device after entering into radio frequency range of the wireless access point, and performing encryption for the connection;

(b) sending an IM table supported by the wireless access point from the wireless access point to the wireless slim terminal device;

(c) selecting one or more IMs to be accessed by the wireless slim terminal device and notifying the wireless access point an instant message user identifier desired to be accessed and its corresponding IM type;

(d) the wireless access point accessing to the server of one or more IMs selected by the wireless slim terminal device over the IP network by utilizing the instant message user identifier and relevant information provided by the wireless slim terminal device; the server of one or more IMs reverting to the wireless access point with an accessing result to refresh the relevant communication information no matter whether the access is done or not, which includes: if the access being done, the server of one or more IMs reverting to the wireless access point with a command of access done, and may transmitting a user's contact list stored on the server to the wireless access point; the wireless access point translating this access done command into one that is compliant with the definition of the short distance wireless communication protocol between the wireless slim terminal device and the wireless access point, and notifying the wireless slim terminal device with the translated command of access done, while, if a contact list being required by the user accessed by the wireless slim terminal device, the wireless access point translating the data of the user's contact list into the data format in compliant with the definition of the short distance wireless connection protocol between the wireless slim terminal device and the wireless access point, and transmitting the translated data to the wireless slim terminal device;

(e) in case of the wireless slim terminal device's request for communicate with a certain remote terminal device in a certain IM, the wireless slim terminal device transmitting to the wireless access point a command for establishing connection with the remote terminal device of the IM with the user identifier of the remote terminal device and the type of the IM, the wireless access point identifying the type of the IM, and translating this request command of establishing connection into a request command of establishing connection with the IM over the IP network, and transmitting the translated command to the server of IM.

(f) in case of a remote terminal device of an IM's request for communication with the wireless slim terminal device, the remote terminal device transmitting to the server of IM a request to establish connection with the wireless slim terminal device, the server of IM transmitting to the wireless access point over the IP network a command of request for establishing connection with the instant message user identifier of the wireless slim terminal device, the wireless access point translating the command of establishing connection into a command compliant with the short distance wireless communication protocol between the wireless access point and wireless slim terminal device and transmitting the translated command to the wireless slim terminal device, in the meanwhile, notifying the wireless slim terminal device the type of the IM and the instant message user identifier contained in the received command in order to distinguish same instant message user identifier probably existing in different IMs.

(g) establishing communication connection between the wireless slim terminal device and the remote terminal device through a wireless access point so as to enable mutual exchange of messages and data, and/or audio/video calls;

(h) disconnecting the wireless slim terminal device with the remote terminal device when the communication being concluded;

(i) updating on-line state in real time between the wireless slim terminal device and the server after the wireless slim terminal device being connected to the server via the wireless access point;

(j) transmitting a command by the wireless access point through the IP network to log out or disconnect with the server of one or more IMs which are selected and accessed by the wireless slim terminal device in case that the wireless slim terminal device is out of the radio frequency range which results in disconnection of short distance wireless connection.

According to the invention, an access network system for enabling a wireless slim terminal device accessing to one or more kinds of communication sub-systems is provided. Said access system comprises:

a wireless slim terminal device for establishing a short distance wireless connection with a wireless access point; and

a wireless access point being provided with at least one IM and connecting the server of at least one IM and a remote terminal device via an IP network;

wherein

the wireless slim terminal device notifies the wireless access point with at least one instant message user identifier, the wireless access point automatically log in at least one IM corresponding to said at least one instant message user identifier; the wireless access point translating the command and data interacting with the wireless slim terminal device in conformity with a short distance wireless communication protocol into a corresponding command and data in conformity with the protocol of said at least one IM, and transmitting them to the corresponding server of the IM and the remote terminal device, in the meanwhile, the wireless access point translating the command and data interacting with the server of said at least one IM in conformity with of different IM protocols and the remote terminal device into the command and data in conformity with the short distance wireless communication protocol and transmitting them to the wireless slim terminal device.

According to the invention, a wireless slim terminal device is provided, which comprises:

a display module for displaying a contact list and communication data of at least one IM logged in by its user identifier;

a keyboard module for input operation;

an audio/video input/output module for voice and video call;

a short distance wireless communication module for establishing wireless connection with a wireless access point;

a user identifier module for storing an instant message user identifier of at least one IM; and

a communication control module for transmitting the user identifier to the wireless access point so as to finish automatically logging in the IM, and controlling the wireless slim terminal device for communicate with the servers of different IMs and remote terminal devices in an IP network via the wireless access point.

According to the invention, a wireless access point is provided, which comprises:
at least one IM protocol for connecting, via an IP network, the server of at least one IM and a remote terminal device, and the IM protocol being added or reduced through installation and configuration; the wireless access point being able to send, through interacting with a certain specific server in the IP network or the servers of various IMs, a specific check order to look up whether the server has issued a command of adding new IM protocols as it is needed, if needed, the IM protocol will being automatically downloaded and installed; or to look up whether it is needed to upgrade an IM protocol, if needed, the IM protocol will being automatically downloaded and installed; or to further check whether it is needed to terminate or delete an IM protocol, and if needed, performing the termination or deleting; in this way, the wireless access point can be automatically updated, upgraded and maintained;
a short distance wireless communication module for communicating with the wireless slim terminal device via wireless connection;
a communication control module for automatically logging in the corresponding IM according to the user identifier provided by the wireless slim terminal device, controlling the communication between various IMs and one or more wireless slim terminal device, and performing translation of command and data between various IM protocols and the short distance wireless communication protocol supported by the wireless access point and the wireless slim terminal device, wherein in controlling the communication between various IMs and the wireless slim terminal device, said communication control module of the wireless access point will control the connection between the wireless slim terminal device and the wireless access point according to the bandwidth resource of wireless connection between the wireless access point and one or more wireless slim terminal device and the bandwidth resource of the IP fixed network connection between the remote terminal devices of one or more IMs; if the bandwidth of the wireless connection or IP network is not enough, the wireless access point will reset the bandwidth occupied by the existing wireless slim terminal device as connected so as to reserve more bandwidth resource for other wireless slim terminal devices to establish new communication connection, however, when the reserved bandwidth resource is still not enough for establishing new communication connection, the wireless access point will notify a failure of connection and refuse establishment of new communication connection.

In addition, in order to improve safety of data transmission and prevent disclosure of user data at the wireless access point, the user may select to encrypt data so that the data transmitted by the wireless slim terminal device via the wireless access point and various IMs is encrypted, which comprises:

in an initial safe environment, the wireless slim terminal device and various IMs performing negotiation the key for encryption and decryption of the data and the algorithm for the encryption, and storing them in the wireless slim terminal device;

encrypting the data transmitted to the wireless access point by the wireless slim terminal device in a designated encryption algorithm and encryption key, transmitting the encrypted data by the wireless access point transparently to the servers of various IMs and the remote terminal device in the IP network, the servers of various IMs and the remote terminal device performing decryption with a designated encryption algorithm and decryption key;

encrypting the data transmitted to the wireless access point by the servers of various IMs and their remote terminal devices with a designated encryption algorithm and encryption key, transmitting the encrypted data by the wireless access point transparently to the wireless slim terminal device, the wireless slim terminal device performing decryption with the designated encryption algorithm and the decryption key; whereby

the wireless access point is unable to see the data transmitted between the wireless slim terminal device, various IMs and their remote terminal devices, the wireless access point only performs data transmission in a transparent way.

According to the invention, it is not necessary for the wireless slim terminal device to be configured in a high level and communicate with other IMs directly. The wireless slim terminal device connects with the wireless access point through a single short distance wireless communication protocol, transferring lots of work for communicating with various IMs to the wireless access point, the wireless access point abstracts and normalizes those communication results with various IMs to report them to the wireless slim terminal device. In this way, the wireless access point abstracts and shields different IMs from the wireless slim terminal device so that it is compatible to various IMs in different IP networks. The user does not need to operate on the wireless access point, he/she can accomplish communication connection with various IMs in a same operation mode through one wireless slim terminal device.

The wireless access point may be personal computers, or home or public wireless access gateway. In case a new IM is added in the wireless access point, the user can access this new IM through the wireless slim terminal device without upgrading applications on the wireless slim terminal device, thereby obtaining a better system compatibility and expansibility.

Furthermore, no matter where the user carrying the wireless slim terminal device is, as long as there is a wireless access point available, the user can access various IMs over the IP network, which greatly simplifies the use of IMs for the users.

### BRIEF DESCRIPTION OF THE FIGURES

It will be helpful to understand the purpose and advantages of the present invention that the preferable embodiments of the invention are explained in detail by means of drawings, wherein:

FIG. 1 is a structural block diagram illustrating how a wireless slim terminal device communicates with a server of an IM and a remote terminal device via a wireless access point;

FIG. 2 is a hardware block diagram of a wireless slim terminal device;

FIG. 3 is a hardware block diagram of a wireless access point;

FIG. 4 is a diagram illustrating the steps of the wireless slim terminal device communicating with the server and remote terminal device via a wireless access point;

FIG. 5 is a structural block diagram of a communication link table of the wireless access point;

FIG. 6 is a flow chart illustrating how one or more wireless slim terminal devices communicate with the remote terminal device of a plurality of IMs simultaneously; and

FIG. 7 is a structural block diagram illustrating how to encrypt data transmitted between the wireless slim terminal device, IM server and remote terminal device.

### DETAILED DESCRIPTION OF THE PREFERRED EMBODIMENTS

FIG. 1 is a structural block diagram illustrating how a wireless slim terminal device communicates with a server, of an IM and a remote terminal device via a wireless access point.

As shown in FIG. 1, a wireless access point 130 is wirelessly connected to a wireless slim terminal device 100 via short distance wireless communication connection S100, it may also be wirelessly connected to a plurality wireless slim terminal devices 110, 120 simultaneously via short distance wireless communication connection S110, S120. The wireless access point 130 comprises various kinds of access modules 140, 150 and 160 of IM, wherein access module 140 of IM is in connection S130 with a server 170 of IM, whereas access modules 150 and 160 of IM are in respective connection S140 and S150 with corresponding servers 180 and 190 of IM. Servers 170, 180 and 190 of IM are further in connection S180 with remote terminal devices 105, 115, 125, 135, 145, 155, 165, 175 and 185, respectively. After accessing to corresponding servers 170, 180 and 190 of IM via wireless access point 130, wireless slim terminal devices 100, 110 and 120 may communicate with corresponding remote terminal devices respectively.

Here, short distance wireless communication connection S100 may be Bluetooth link, WiFi link, UWB link and wireless USB link. Accordingly, the wireless slim terminal devices 100, 110 and 120 may be Bluetooth mobile phone, Bluetooth hands-free terminal device and Bluetooth cordless phone terminal device, the wireless access point 130 may be a PC supporting Bluetooth technology, and the access modules 140, 150 and 160 of IM may be MSN, Skype, QQ etc.

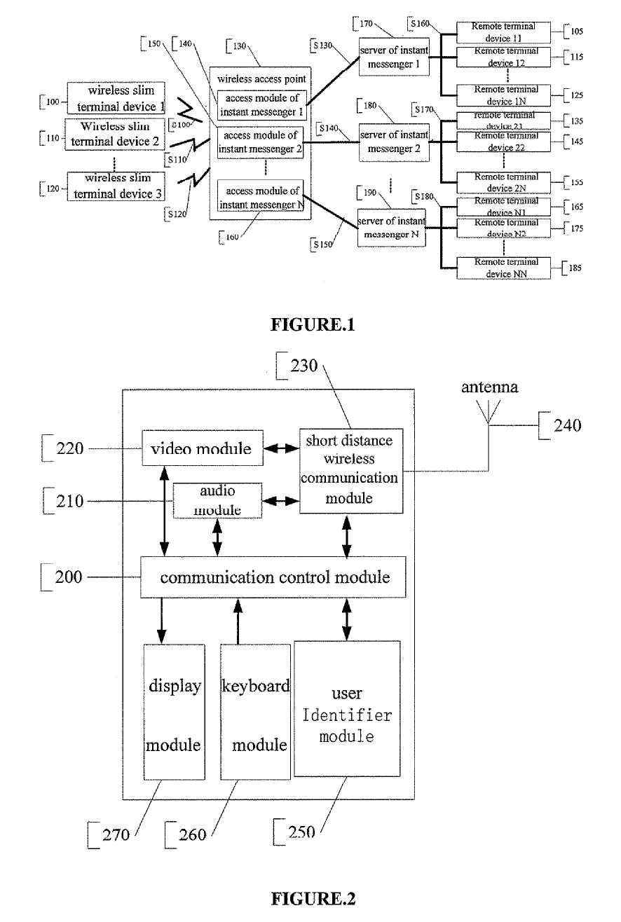

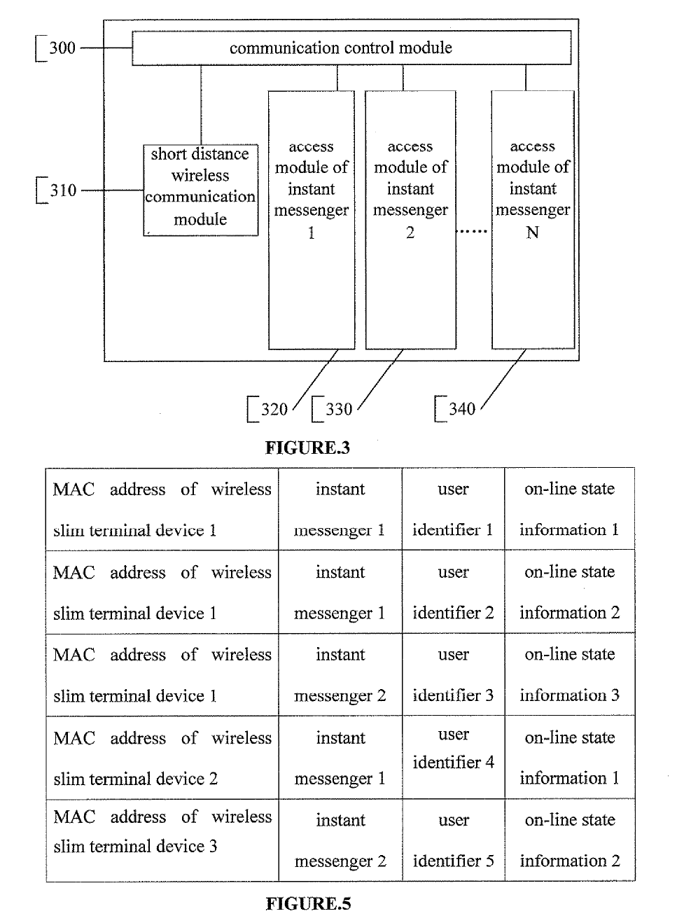

FIG. 2 is a hardware block diagram of a wireless slim terminal device.

As shown in FIG. 2, said wireless slim terminal device comprises a communication control module 200, an audio module 210, a video module 220, a short distance wireless communication module 230, an antenna 240, a user identifier module 250, a key press module 260 and a display module 270.

The key press module 260 is intended to input command and data. The audio module 210 is intended to input/output audio data. The video module 220 is intended to collect literal data or image data. The display module 270 is intended to display literal data or image data. The short distance wireless communication module 230 and the antenna 240 are intended to transmit command and data to the wireless access point and receive command and data from the wireless access point.

The user identifier module 250 is intended to store type of IM employed by the wireless slim terminal device and its associated instant message user identifier, for example, user name, password, etc. Here, the user identifier module 250 can be either a separate memory, or a SIM card (e.g. the SIM card in a Bluetooth mobile phone).

The communication control module 200 is in connection with the audio module 210, the video module 220, the short distance wireless communication module 230, the user identifier module 250, the key press module 260 and the display module 270 to control respective modules. The communication control module 200 translates various command and data that are input from the key press module, the audio and video module into the command and data in compliance with the definition of the short distance wireless technology, and transmits them to the wireless access point via the short distance wireless communication module 230 and the antenna 240. In the meanwhile, the communication control module parses the command and data that are received from the wireless access point in compliance with the definition of the short distance wireless technology so as to perform relevant operations of the command and data.

The communication control module 200 is in connection with the user identifier module 250 from where the instant message user identifier is acquired and transmitted to the wireless access point through the short distance wireless communication module 230 and the antenna 240 for making access.

The communication control module 200 is in connection with the key press module 260, the audio module 210, the video module 220 and the display module 270, such that the communication control module 200 receives input data or control command and encodes the control command and input data together with the instant message user identifier and receiver's user identifier (if any) as the command and data of short distance wireless technology and transmits them to the wireless access point when the user of the wireless slim terminal device inputs literal data or control command via the key press module 260 under a certain instant message user identifier, inputs audio data via the audio module 210, or collects video data via the video module 220.

The communication control module 200 also receives command and data of the short distance wireless technology transmitted from the wireless access point through the short distance wireless communication module 230 and the antenna 240. The communication control module 200 will parse the command and data of short distance wireless technology into control command, data for output, the instant message user identifier and the initiator user identifier, and transmit the data for output to an appropriate output module, such as audio module 210, display module, etc., for making an appropriate output according to the control command.

Preferably, the communication control module 200 receives various kinds of communication information returned by the server of IM from the wireless access point, for example, contact list information in MSN, and transmits the communication information to display module 270 for displaying to the user.

FIG. 3 is a hardware block diagram of a wireless access point.

As shown in FIG. 3, said wireless access point comprises a communication control module 300, a short distance wireless communication module 310 and a plurality of access modules 320, 330 and 340 of IM.

The short distance wireless communication module 310 is intended to establish wireless communication connection with the wireless slim terminal device. The access modules 320, 330 and 340 of IM are connected to the corresponding server of IM and the remote terminal device via, for example, IP network.

The communication control module 300 is connected to a short distance communication module 310 and an access modules 320, 330 and 340 of IM, so as to deal with the command and data of the wireless slim terminal device received via the short distance wireless communication module 310 and the command and data of the server of IM received via access module 320, 330 or 340 of IM.

The communication control module 300 has protocol translating function for translating the command and data of the wireless slim terminal device from command and data of short distance wireless communication protocol into those of various IM protocols, and transmits the translated command and data to corresponding access module 320, 330 or 340 of IM; in the meanwhile, the communication control module 300 also translates the command and data of the server of IM from command and data of various IM protocols into those of short distance wireless communication protocol and transmits the translated command and data to the short distance wireless communication module 310.

Specifically, upon receiving command and data of the wireless slim terminal device, the communication control module 300 firstly parses the command and data of the short distance wireless communication protocol and obtains from said command an instant message user identifier so as to identify the type of IM, the initiator user identifier and the receiver user identifier. According to the identified type of IM, the communication control module 300 translates the command and data of the short distance wireless communication protocol into the command and data of the identified IM protocol, the command including the identified initiator's user identifier and the receiver's user identifier, and forwards the translated command and data of the IM protocol to an corresponding access module 320, 330 or 340 of IM so as to transmit them to the corresponding server of IM.

When the communication control module 300 receives, via corresponding access module 320, 330 or 340 of IM, the command and data transmitted by a certain server of IM, the communication control module 300 firstly identifies the type of IM, and based on this, parses the command and data of the IM protocol, extracts the initiator user identifier and receiver user identifier. According to the identified type of IM, the communication control module 300 translates the command and data of the IM protocol into the command and data of short distance wireless communication protocol, and transmits the translated command and data to the corresponding wireless slim terminal device via short distance wireless communication module 310 according to the extracted receiver uses identifier.

Here, the communication control module 300 is provided with a communication link table for recording the types of respective IMs that are accessed by respective wireless slim terminal device through the wireless access point where they connected, the corresponding user identifiers and the addresses of respective short distance wireless modules of the wireless slim terminal device. After the communication control module identifies the type of IM and extracts the receiver user identifier from the command of IM protocol, the communication control module will find the type of the IM and the address of the wireless slim terminal device corresponding to the receiver user identifier stored in the communication link table, so as to transmit the command and data to the correct wireless slim terminal device.

The communication link table for recording state information of an user represented by an instant message user identifier of the wireless slim terminal device will be updated along with the change of the state information, and the change of the state of the connected server of IM. Furthermore, the communication control module 300 will be updated in the communication link table, that is, where there is a state change, the associated wireless slim terminal device or the server of IM is notified about the changed state.

When the user's on-line state information represented by the user identifier of the wireless slim terminal device changes, the communication control module 300 updates the communication link table, and notifies the corresponding server of IM of the user's current on-line state information represented by the user identifier in accordance with the type of IM corresponding to the user identifier.

When the connection between the wireless access point and a certain server of IM is not stable or the server disconnects on its own initiative, the communication control module 300 will update the communication link table of the wireless slim terminal device associated with that IM by changing the current state information for users represented by all instant message user identifiers of this corresponding IM into Off line state and notifies the associated wireless slim terminal device.

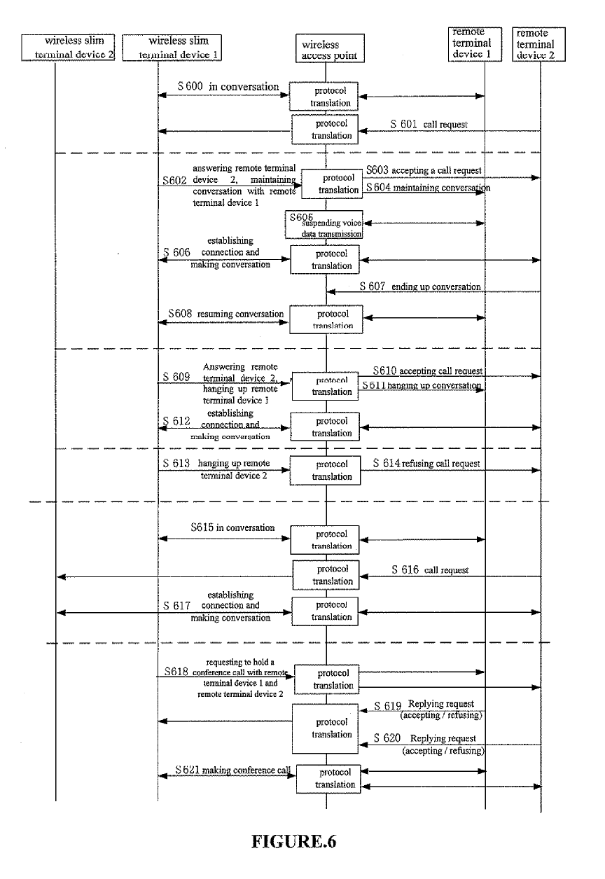

In a preferable embodiment of the present invention, a communication link table as an example is in a structure as shown in FIG. 5. Here, the wireless access point connects three wireless slim terminal devices 1, 2 and 3, wherein the wireless slim terminal device 1 is accessed to Evil (which may be, for example, Skype) with user identifier 1 and user identifier 2, and is also accessed to IM2 (which may be, for example, MSN) with user identifier 3, their states being state 1 (e.g. on-line state), state 2 (e.g. off-line state) and state 3 (e.g. busy state) respectively. The wireless slim terminal device 2 is accessed to IM1 with user identifier 4, the state of which is state 1. The wireless slim terminal device 3 is accessed to IM2 with user identifier 5, the state of which is state 2.

Preferably, the communication control module 300 may interact with an install and configure server via an IP network and be unifiedly configured by the install and configure server so as to decide adding or removing access modules of IM; various access modules of IM are also able to perform upgrade or update of IM automatically through the interaction of the respective IM access module with the respective servers of IM.

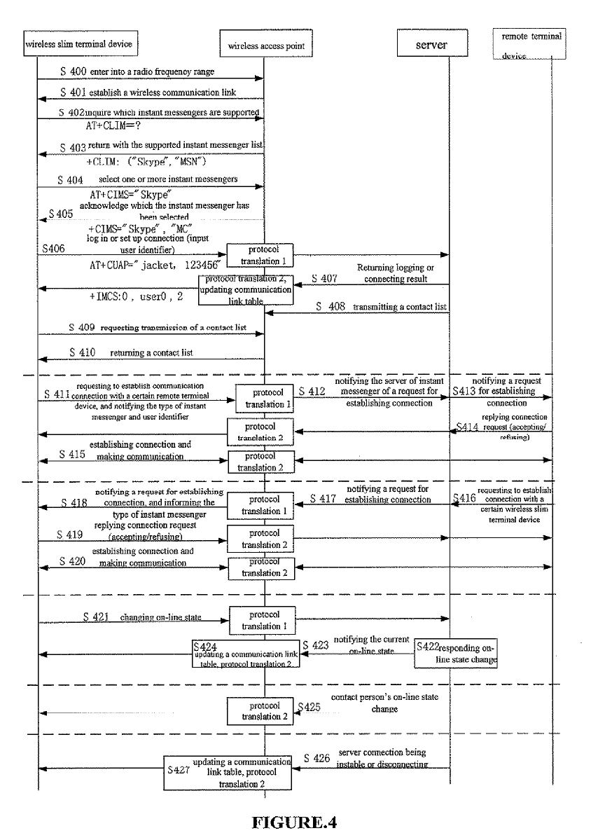

FIG. 4 is a diagram illustrating the steps of the wireless slim terminal device communicating with the server of IM and the remote terminal device via a wireless access point.

In this figure, “protocol translation 1” refers to the wireless access point translating the command and data of the short distance wireless communication protocol between the wireless slim terminal device and wireless access point into the command and data of IM protocol; “protocol translation 2” refers to the wireless access point translating the command and data of IM protocol into the command and data of the short distance wireless communication protocol between the wireless slim terminal device and wireless access point.

Next, the communication process performed by the wireless slim terminal device to communicate with the server and remote terminal device via a wireless access point will be explained in detail with reference to “AT” command. “AT” command as shown in this figure is custom AT extended command produced during the process, however, the present invention is not limited to this “AT” command and its configuration, various changes in forms and details are also practicable.

Step S400: the wireless slim terminal device enters into the radio frequency range, the wireless access point and wireless slim terminal device establish short distance wireless connection.

Steps S401 to S404: after the short distance wireless connection is established, the wireless slim terminal device transmits the command “AT+CLIM=?” to the wireless access point to inquiry which IMs are supported by the wireless access point. The wireless access point returns the supported IM table to the wireless slim terminal device, for example, the returning of command “+CLIM: (“Skype”, “MSN”)” indicates the IM supported by the wireless access point is Skype and MSN. Optionally, the wireless access point looks up the communication link table, and uses the IM in connection to generate a supported IM table and returns this table to the wireless slim terminal device. The wireless slim terminal device selects one or more IMs, for example, transmits the command “AT+CIMS=Skype” and/or “AT+CIMS=MSN” to the wireless access point, representing that Skype and/or MSN IM is selected. The wireless access point selects IM Skype and/or MSN according to the command, returns the command “+CIMS=“Skype”, “MC”” and/or “+CIMS=“MSN”, “MC”” to the wireless slim terminal device, and notifies that the Skype and/or MSN IM have/has been selected.

Steps S405 to S406: the wireless slim terminal device provides the wireless access point with the type of IM and the associated instant message user identifier, for example, user name and password, for accessing to the IM. Here, the user name and password can be manually input by the user, and also be pre-stored in the wireless slim terminal device for the user's selection. If the user identifier is manually input, the wireless slim terminal device will input the user identifier after selecting a certain IM, the wireless slim terminal device records the type of the IM and the user identifier. If the user identifier pre-stored in the wireless slim terminal device is used for accessing, the wireless slim terminal device will, after selecting a certain IM, look up automatically the stored user identifier corresponding to the type of this IM and provide the user identifier to the user for making a selection.

The wireless slim terminal device contains the acquired instant message user identifier in the command provided to the wireless access point, for example, “AT+CUAP=“jacket”, 123456, Skype” means the user name is “jacket”, the password is “123456”, and the type of IM is Skype. The wireless access point extracts the instant message user identifier, and starts up the corresponding access module of IM according to the assigned IM type, here it is the Skype access module that transmits the instant message user identifier to the corresponding Skype server via protocol translation 1; the Skype server authenticates the user identifier and returns an access result.

After performing protocol translation 2 on the access result, the wireless access point transmits it to the wireless slim terminal device, the command is, for example, “+IMCS: 2”, here 2 represents that the access result of the instant message user identifier is Online; there are several other states, for example, 0(Unknown), 1(Offline), 3(Away), 4(Not available), 5(DND/Don't disturb), etc. The wireless slim terminal device displays the returned access result on the display module to help the user directly perceive the current state of the instant message user identifier. In the meanwhile, the wireless access point updates the communication link table according to the access result of the instant message user identifier, for example, creating a new item of a corresponding instant message user identifier, or modifying the state of the original items.

Steps S408 to S410: generally, after accessing, the server of 1M automatically transmits a contact list corresponding to the instant message user identifier to the wireless access point. The wireless slim terminal device may request transmission of the contact list corresponding to an instant message user identifier of a certain IM to the wireless access point. Alternately, the wireless access point can return the contact table to the associated wireless slim terminal device together with the instant message user identifier, once the contact table is received. Optionally, the wireless access point preferably returns the contact list that is currently accessed to the server and kept in connection.

When a user of the wireless slim terminal device desires to communicate (for example, transmitting messages, making a call, demanding video and transferring file, etc.) with a certain contact person in the contact list, i.e. a certain remote terminal device for the corresponding contact person, the following operations can be performed:

Steps S411 to S415: the wireless slim terminal device notifies the wireless access point of the type of IM, the instant message user identifier and receiver user identifier, i.e. the user identifier of the remote terminal device, the wireless access point identifies the type of IM, performs protocol translation 1 for a command containing the instant message user identifier, the receiver user identifier and a request for establishing a connection and then transmits them to the server of IM via the corresponding access module of IM, the latter notifies this remote terminal device according to the receiver user identifier with this request command of establishing connection.

When a reply from the remote terminal device is received by the wireless access point through the server of IM, the wireless access point identifies the type of IM, extracts the instant message user identifier therefrom, and looks up the corresponding wireless slim terminal device from the communication link table based on this, then performs protocol translation 2 on the command of the IM protocol, and notifies the corresponding wireless slim terminal device. If the reply is accepting the request for establishing connection, the wireless slim terminal device establishes a connection with the remote terminal device to make communication.

When a request (for example, transmitting messages, making a call, demanding video, transferring file, etc.) for establishing communication connection is received from a certain remote terminal device, the operating process is as follows:

Step S416 to S420: the wireless access point receives a request for establishing communication connection from the server of IM. The wireless access point identifies the type of IM according to the access module of IM, extracts the initiator user identifier and receiver user identifier from the request for establishing communication connection, and adopts protocol translation 2 to translate command of the request for establishing communication connection, the type of IM, the initiator user identifier and receiver user identifier into the command of the short distance wireless communication technology, in the meanwhile, the wireless access point looks up the address of the corresponding wireless slim terminal device according to the communication link table and transmits the translated command to the corresponding wireless slim terminal device. The wireless slim terminal device will accept or refuse to transmit, to the wireless access point, the command of the request for establishing communication connection, the initiator user identifier, i.e. the instant message user identifier of the remote terminal device, and the receiver user identifier, i.e. the user identifier of the remote terminal device. The wireless access point transmits the command that undergoes protocol translation 1 to the server of IM, the server of IM notifies the remote terminal device according to the receiver user identifier. If the wireless slim terminal device accepts the request for establishing connection, the wireless slim terminal device establishes connection with the remote terminal device to make communication.

Preferably, when the on-line state of the user or contact person of the wireless slim terminal device has a change, the wireless access point and the wireless slim terminal device perform the following operations:

Steps S421 to S424: when a certain instant message user identifier in the wireless slim terminal device has a state change, the wireless access point will notify the server of IM in real time. The server of IM responds to the change of user state and notifies the wireless access point of the user's current state, the wireless access point notifies the wireless slim terminal device after undergoing protocol translation 2 and updates the communication link table.

When the wireless slim terminal device desires to disconnect from a certain server of IM, the wireless access point translates the command of the short distance wireless communication protocol into command of the corresponding IM, and notifies the server of IM. After disconnection is successful, the wireless access point notifies the wireless slim terminal device and updates the communication link table. When the wireless slim terminal device transmits the command to the wireless access point to re-access to a certain server of IM, the wireless access point translates command of the short distance wireless communication protocol into command of the corresponding IM, and notifies the server of IM. After access, the wireless access point notifies the wireless slim terminal device and updates the communication link table. When the wireless slim terminal device is off the radio frequency connection range of the wireless access point, the wireless connection disconnects, the wireless access point looks up the types of all IMs to which the wireless slim terminal device is accessed in the communication link table, and notifies the corresponding instant message server to disconnect, and then deletes all entries associated with the wireless slim terminal device from the communication link table.

Step S425: when the contact person of the remote terminal device has a change in state (for example, on-line, off-line, departure, busy, etc.), the server of IM will notify the wireless access point in real time, the wireless access point notifies the wireless slim terminal device of the new contact list after undergoing protocol translation 2.

Step S426: when the connection of the wireless access point with a certain server of IM is instable or the server disconnects on its own initiative, the wireless access point looks up, in the communication link table, the wireless slim terminal device involved in all communication associated with the type of the IM, notifies the involved wireless slim terminal device of this state change, and deletes entries associated with the communication system type from the communication link table at the same time.

FIG. 6 is a flow chart illustrating how one or more wireless slim terminal device communicates with the remote terminal device of a plurality of IMs simultaneously.

To facilitate simple and clear statement, such part as the server of IM is omitted in FIG. 6. In the meanwhile, remote terminal device 1 and remote terminal device 2 that are taken as examples can be not only the users of the same IM, but also the users of different IMs, moreover, they are not limited to two remote terminal devices only and can be a plurality of remote terminal devices of a plurality of IMs. The process that the wireless slim terminal device communicates with a plurality of remote terminal devices is explained below taking FIG. 6 as an example.

The first case: the wireless slim terminal device receives a connection request from the other remote terminal device during the process of communicating with one remote terminal device.

Step S600: wireless slim terminal device 1 is communicating with remote terminal device 1.

Step S601: remote terminal device 2 requests to connect to and communicate with wireless slim terminal device 1, the wireless access point acquires, from the connection request of remote terminal device 2, the type of 1M, the initiator user identifier, i.e. the user identifier of remote terminal device 2, and the receiver user identifier, i.e. the instant message user identifier of wireless slim terminal device 1, looks up an address of the corresponding wireless slim terminal device 1 from the communication link table according to the type of IM and the acquired instant message user identifier of wireless slim terminal device 1, and transmits the protocol-translated connection request of remote terminal device 2 to wireless slim terminal device 1 according to the address.

Wireless slim terminal device 1 selects a next-step operation according to needs, here explanation is made taking conversation communication as an example:

Steps S602 to S608: if the user of wireless slim terminal device 1 selects to accept the connection request of remote terminal device 2, but desires to maintain conversation with remote terminal device 1, wireless slim terminal device 1 encodes its instant message user identifier, the type of IM, command of accepting connection request and the user identifier of remote terminal device 2 into command 1 of the short distance wireless communication protocol and transmits it to the wireless access point, and at the same time, encodes the type of 1M involved with the conversation that the user desires to maintain, the corresponding instant message user identifier, command of maintaining conversation and user identifier of remote terminal device 1 into command 2 of the short distance wireless communication protocol and transmits it to the wireless access point.

The wireless access point translates command 1 into command of the IM protocol corresponding to remote terminal device 2, and notifies remote terminal device 2 that the connection request is accepted, in the meanwhile, the wireless access point translates command 2 into command of the 1M protocol corresponding to remote terminal device 1, and notifies remote terminal device 1 to maintain conversation.

Therefore, the wireless access point continues to maintain the conversation link between wireless slim terminal device 1 and remote terminal device 1, but suspends transmission of voice data from remote terminal device 1 to wireless slim terminal device 1, and stops transmission of voice data from wireless slim terminal device 1 to remote terminal device 1; in the meanwhile, the wireless access point establishes conversation connection between wireless slim terminal device 1 and remote terminal device 2, is responsible for performing corresponding protocol translation on the received voice data that is transmitted by wireless slim terminal device 1 or remote terminal device 2 and transmits the translated data to the opposite party.

When the wireless access point receives command of ending up conversation sent by the remote terminal device 2 or the wireless slim terminal device 1, the wireless access point disconnects conversation connection between remote terminal device 2 and wireless slim terminal device 1, and then restart to receive voice data sent by the remote terminal device 1 again, after the voice data being processed under a corresponding protocol translation, the wireless access point transmits it to the wireless slim terminal device 1, while the received voice data sent by the wireless slim terminal device 1 is translated into the IM protocol of the remote terminal device 1 and transmitted it to the remote terminal device 1, that is, the conversation between the wireless slim terminal device 1 and the remote terminal device 1 is resumed.

Steps S609 to S612: if the user of the wireless slim terminal device 1 selects to answer the remote terminal device 2, but hangs up the remote terminal device 1, the wireless slim terminal device 1 will encode the type of IM included in the call connection requested, the associated instant message user identifier, acceptance command of the call request, and the user identifier of the remote terminal device 2 into a command 1 of the short distance wireless communication protocol and transmits it to the wireless access point. In the meanwhile, the wireless slim terminal device 1 encodes the type of IM included in the call connection to be hung up, the associated instant message user identifier, call termination command, and the user identifier of the remote terminal device 1 into a command 2 of the short distance wireless communication protocol and transmits it to the wireless access point.

The wireless access point translates command 1 into command of the IM protocol of remote terminal device 2, and notifies remote terminal device 2 that the connection request is accepted, in the meanwhile, the wireless access point translates command 2 into command of IM protocol of remote terminal device 1 and notifies remote terminal device 1 to disconnect conversation. The wireless access point disconnects conversation connection between wireless slim terminal device 1 and remote terminal device 1, and establishes conversation connection between wireless slim terminal device 1 and remote terminal device 2 at the same time, that is, the wireless access point receives voice data sent by remote terminal device 2, translates the voice data from the IM protocol of remote terminal device 2 into the short distance wireless communication protocol and then transmits the translated data to wireless slim terminal device 1, in the meanwhile, the wireless access point receives voice data sent by wireless slim terminal device 1, translates the voice data from the short distance wireless communication protocol into sub-communication protocol of remote terminal device 2 and then transmits the translated data to remote terminal device 2.

Steps S613 to S614: if selecting to hang up remote terminal device 2, wireless slim terminal device 1 encodes the type of associated IM, the corresponding instant message user identifier, command of refusing call request and user identifier of remote terminal device 2 into command of the short distance wireless communication protocol, and transmits the command to the wireless access point. The wireless access point translates the command of refusing call request of the short distance wireless communication protocol into the command of IM protocol of remote terminal device 2, and notifies remote terminal device 2 to hang up call according to the user identifier of remote terminal device 2.

The second case: two wireless slim terminal devices communicate with two remote terminal devices respectively via the same wireless access point.

Steps S615 to S617: wireless slim terminal device 1 and remote terminal device 1 are making conversation; remote terminal device 2 requests to transmit a call request to wireless slim terminal device 2. The user of wireless slim terminal device 2 accepts a call request of remote terminal device 2, and transmits the command of accepting request to the wireless access point, then the wireless access point notifies remote terminal device 2.

In this case, when receiving the command or voice data transmitted by remote terminal device 1 or remote terminal device 2, the wireless access point firstly parses the type of IM, the initiator user identifier and receiver user identifier, i.e. the instant message user identifier of wireless slim terminal device, of the command or data, and then looks up an address of the corresponding wireless slim terminal device in the communication link table according to the type of IM and instant message user identifier, whereby determining the command or data is transmitted to wireless slim terminal device 1 or wireless slim terminal device 2. After that, the wireless access point performs protocol translation on said command or data according to the looked-up address of wireless slim terminal device and transmits it to wireless slim terminal device 1 or wireless slim terminal device 2.

When wireless slim terminal device 1 or wireless slim terminal device 2 transmits command or voice data, the wireless access point firstly parses the type of 1M, initiator user identifier and receiver user identifier of the command or data, and then selects the access module of IM according to the type of IM, so as to transmit the command or data to remote terminal device 1 or remote terminal device 2.

The third case: a wireless slim terminal device and a plurality of remote terminal devices hold a conference call.

Steps S618 to S621: wireless slim terminal device 1 files a request before the wireless access point for holding a conference call with remote terminal device 1 and remote terminal device 2.

If remote terminal device 1, remote terminal device 2 and wireless slim terminal device 1 are the user of the same IM the wireless access point will translate the conference call request command into request command of the IM protocol and notify remote terminal device 1 and remote terminal device 2 respectively; remote terminal device 1 and remote terminal device 2 accept or refuse this request and return a result of answering the request to the wireless access point, the wireless access point then translates the result of answering the request into command of the short distance wireless communication protocol between wireless slim terminal device 1 and wireless access point and notifies wireless slim terminal device 1. If remote terminal device 1 and remote terminal device 2 both accept a request for conference call, wireless slim terminal device 1 establishes connection with remote terminal device 1 and remote terminal device 2 to hold a conference call, comprising: the wireless access point translates and composites voice data from wireless slim terminal device 1 and remote terminal device 2 into input voice data of IM protocol of remote terminal device 1, and transmits it to remote terminal device 1; the wireless access point translates and composites voice data from wireless slim terminal device 1 and remote terminal device 1 into input voice data of IM protocol of remote terminal device 2, and transmits it to remote terminal device 2; the wireless access point translates and composites voice data from remote terminal device 1 and remote terminal device 2 into voice data of short distance wireless communication protocol between wireless slim terminal device 1 and wireless access point, and transmits it to wireless slim terminal device 1.

If remote terminal device 1 and remote terminal device 2 are the users of two different IMs, then wireless slim terminal device 1 holds a conference call with remote terminal device 1 of the first IM and remote terminal device 2 of the second IM via the wireless access point, comprising: wireless slim terminal device 1 transmits to the wireless access point the command of requesting for a conference call, the first instant message user identifier of the first IM as used, the second instant message user identifier of the second IM as used, the first user identifier of remote terminal device 1 of the first IM to be connected and the second user identifier of remote terminal device 2 of the second IM; the wireless access point connects remote terminal device 1 of the first IM and remote terminal device 2 of the second IM respectively according to the first user identifier and the second user identifier, and notifies remote terminal deice 1 and remote terminal device 2 of the command of conference call request of wireless slim terminal device 1, then the wireless access point composites voice data of remote terminal device 1 and remote terminal device 2 and transmits it to the wireless slim terminal device; composites voice data of remote terminal device 1 and wireless slim terminal device and transmits it to remote terminal device 2; composites voice data of remote terminal device 2 and wireless slim terminal device and transmits it to remote terminal device 1.

Other communication manners such as text communication and video communication have similar communication process to call communication.

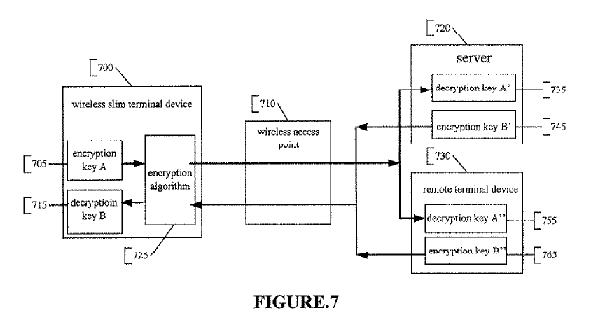

FIG. 7 is a structural block diagram illustrating how to encrypt the data transmitted between the wireless slim terminal device, the server of IM and remote terminal device.

Wireless slim terminal device 700 and server 720 of IM or remote terminal device 730 negotiate data transmission and encrypt data; wireless slim terminal device 700 assigns encryption algorithm 725; wireless slim terminal device 700 notifies server 720 and remote terminal device 730 of encryption key A705, and acquires encryption key B′745 of server 720 and encryption key B″765 of remote terminal device 730 at the same time.

When wireless slim terminal device 700 transmits data to server 720 or remote terminal device 730, the data transmitted by wireless slim terminal device 700 is encrypted by assigned encryption algorithm 725 and encryption key A705 and transmitted to wireless access point 710; wireless access point 710 transparently transmits the encrypted data to server 720 or remote terminal device 730; server 720 receives the encrypted data, and decrypts said data with assigned encrypted algorithm 725 and decryption key A′735, or remote terminal device 730 receives the encrypted data and decrypts said data with assigned encryption algorithm 725 and decryption key A″755.

When server 720 transmits data to wireless slim terminal device 700, the data transmitted by server 720 is encrypted by assigned encryption algorithm 725 and encryption key B′745 and transmitted to wireless access point 710; wireless access point 710 transparently transmits the encrypted data to wireless slim terminal device 700; wireless slim terminal device 700 receives the encrypted data and decrypts said data with assigned encryption algorithm 725 and decryption key B715.

When remote terminal device 730 transmits data to wireless slim terminal device 700, the data transmitted by remote terminal device 730 is encrypted by assigned encryption algorithm 725 and encryption key B″765 and transmitted to wireless access point 710; wireless access point 710 transparently transmits the encrypted data to wireless slim terminal device 700; wireless slim terminal device 700 receives the encrypted data and decrypts said data with assigned encryption algorithm 725 and decryption key B 715.

Thus, wireless access point 710 is impossible to see the data transmitted between wireless slim terminal device 700, server 720 and remote terminal device 730, thereby improving safety of data transmission.

Although the present invention is illustrated and described with reference to its preferable embodiments, those ordinarily skilled in the art shall understand that various changes in form and detail are allowable in the case of not deviating from spirit and scope of the invention defined in the appended Claims.

1-17. (canceled)

18. A communication method for enabling access by a wireless slim terminal device to an Instant Messenger through a wireless access point, wherein the wireless access point is capable of connecting with an Instant Messenger server and a remote terminal device, the method comprising the steps of
A) establishing, by the wireless slim terminal device, a short distance wireless connection with the wireless access point;
B) notifying the wireless access point that a corresponding Instant Messenger type and an associated instant message user identifier are to be accessed by the wireless slim terminal device;
C) accessing the corresponding Instant Messenger through the wireless access point utilizing the instant message user identifier corresponding to the Instant Messenger type and the associated instant message user identifier;
D) translating a first command and data, which conform with a short distance wireless communication protocol, received from the wireless slim terminal device into a second command and data, which conform with a corresponding type-specific Instant Messenger protocol, and transmitting the second command and data to the corresponding Instant Messenger server or the remote terminal device; and
E) translating the second command and data in conformity with the Instant Messenger protocol, which are received from the Instant Messenger server or the remote terminal device, into the first command and data of the short distance wireless communication protocol, and transmitting the first command and data to the corresponding wireless slim terminal device according to the Instant Messenger type or the instant message user identifier contained in the second command and data.

19. The communication method of claim 18, wherein the wireless access point sends a table of supported Instant Messengers to the wireless slim terminal device without external prompt or upon receiving an inquiry from the wireless slim terminal device and after the short distance wireless connection is established.

20. The communication method of claim 18, whereby the wireless access point is configured with a communication link table that can store
A) a wireless slim terminal device address to which the wireless access point is connected,
B) the Instant Messenger type to be accessed by the wireless slim terminal device, and
C) the associated instant message user identifier,
whereby the wireless access point can locate the corresponding wireless slim terminal device address in the communication link table according to the Instant Messenger type and the instant message user identifier, so as to transmit the first command and data to the wireless slim terminal device.

21. The communication method of claim 20, whereby the communication link table further comprises a connection state between the wireless access point and of the Instant Messenger server, such that a change to the connection state of the Instant Messenger server updates the communication link table and notifies the wireless slim terminal device corresponding to the associated instant message user identifier; and the wireless access point generates an Instant Messenger table by listing all Instant Messengers of those Instant Messenger servers that are in the connection state of the updated communication link table.

22. The communication method of claim 18, wherein the wireless access point, accesses the Instant Messenger, then, without further prompting or upon the inquiry of the wireless slim terminal device, the wireless access point transmits to the corresponding wireless slim terminal a contact list received from the Instant Messenger server according to the associated instant message user identifier.

23. The communication method of claim 22, wherein the wireless access point transmits to the wireless slim terminal device only information specific to a contact person whose state is on-line in the contact list.

24. The communication method of claim 18, wherein the wireless slim terminal device can connect a conference call with a first remote terminal device of a first Instant Messenger and a second remote terminal device of a second Instant Messenger, the method comprising the steps of:
A) transmitting a conference call request command from the wireless slim terminal device to the wireless access point, wherein the command includes a first instant message user identifier of a first Instant Messenger, a second instant message user identifier of a second Instant Messenger, a first user identifier of a first remote terminal device to be connected with the first Instant Messenger, and a second user identifier of a second remote terminal device to be connected with the second Instant Messenger;
B) connecting the wireless access point with the first remote terminal device of the first Instant Messenger and the second remote terminal device of the second Instant Messenger, which respectively correspond to the first user identifier and the second user identifier; and
C) transmitting, by the wireless access point, composited voice data of the first remote terminal device and the second remote terminal device to the wireless slim terminal device; transmitting, by the wireless access point, composited voice data of the first remote terminal device and the wireless slim terminal device to the second remote terminal device; and
transmitting, by the wireless access point, composited voice data of the second remote terminal device and the wireless slim terminal device to the first remote terminal device.

25. The communication method of claim 18, wherein the method further comprises a step wherein the wireless slim terminal device encrypts the data transferred between the Instant Messenger server and the remote terminal device through the wireless access point, the encryption step comprising the steps of:
A) the wireless slim terminal device negotiating a key and algorithm for encryption and decryption of data with the Instant Messengers servers and remote terminal devices, respectively, and the wireless slim terminal device storing the key and algorithm;
B) the wireless slim terminal device encrypting the data to be transmitted to the wireless access point with a designated encryption algorithm and encryption key, transmitting the encrypted data transparently from the wireless access point to the Instant Messenger server and the remote terminal device in an IP network, and the Instant Messenger server and the remote terminal device decrypting the data with the designated encryption algorithm and decryption key; and
C) the Instant Messenger server and the remote terminal device encrypting the data to be transmitted to the wireless access point With a designated encryption algorithm and encryption key, transmitting the encrypted data transparently from the wireless access point to the wireless slim terminal device, and the wireless slim terminal device decrypting the data with the designated encryption algorithm and decryption key.

26. A wireless access point that enables a wireless slim terminal device to access an Instant Messenger, the wireless access point comprising:
A) an Instant Messenger access module connecting an instant Messenger server and a remote terminal device;
B) a short distance communication module enabling short distance wireless communication with the wireless slim terminal device; and
C) a communication control module selecting a corresponding access module of the Instant Messenger according to the Instant Messenger type and the instant message user identifier received from the wireless slim terminal device through the short distance communication module, and accessing the corresponding Instant Messenger with the instant message user identifier, and then translating a first command and data received from the wireless slim terminal device in conformity with a short distance wireless communication protocol into a second command and data in conformity with a corresponding Instant Messenger protocol according to the Instant Messenger type, and transmitting second command and data to the corresponding Instant Messenger server or the remote terminal device; and translating the second command and data in conformity with the Instant Messenger protocol received from the Instant Messenger server or the remote terminal device into the first command and data of the short distance wireless communication protocol, and transmitting the first command and data to the corresponding wireless slim terminal device according to the Instant Messenger type and/or the instant message user identifier contained in the second command and data.

27. The wireless access point of claim 26, wherein the communication control module further generates a communication link table that stores addresses of all wireless slim terminal devices to which the communication control module is connected, the Instant Messenger type that is accessed by the wireless slim terminal device, and the associated instant message user identifier, whereby translation between the instant message user identifier and the wireless slim terminal device address is enabled.

28. The wireless access point of claim 27, wherein the communication link table further comprises a connection state between the wireless access point and the supported Instant Messenger server, wherein once the connection state of the Instant Messenger server is changed, the communication link table is updated, and the wireless slim terminal device corresponding to the associated instant message user identifier is notified.

29. The wireless access point of claim 28, wherein the communication control module further generates an Instant Messenger table for all Instant Messengers of those Instant Messenger servers that are in connection state according to the communication link table, and transmits the Instant Messenger table to the wireless slim terminal device without prompting or upon receiving an inquiry from the wireless slim terminal device.

30. A wireless slim terminal device for accessing an Instant Messenger, the wireless slim terminal device comprising:
A) an input/output module for inputting or outputting command or data;
B) a short distance wireless communication module for establishing a short distance wireless connection with a wireless access point;
C) a communication control module for selecting a desired Instant Messenger, acquiring an instant message user identifier for the corresponding Instant Messenger, and transmitting the selected type of Instant Messenger and the corresponding instant message user identifier to the wireless access point through the short distance wireless communication module, and receiving a command and data from the input/output module and forwarding the command and data to the short distance wireless communication module for transmission to the wireless access point.

31. The wireless slim terminal device of claim 30, further comprising a user identifier module for storing the type of the Instant Messenger adopted by the wireless slim terminal device and the associated instant message user identifier; and an instant message user identifier acquired by inputting an input/output module or by selection from the stored instant message user identifier.

32. The wireless slim terminal device of claim 30, wherein the communication control module receives from the wireless access point, an Instant Messenger table for all Instant Messengers supported by the wireless access point through the short distance wireless communication module, and provides a user with the Instant Messenger table for selecting an Instant Messenger through the input/output module.

33. The wireless slim terminal device of claim 30, wherein the communication control module can receive a contact list corresponding to an instant message user identifier from the wireless access point through the short distance wireless communication module, and can output the contact list through the input/output module.

34. An instant message accessing system consisting of the wireless access point of claim 26 and a wireless slim terminal device for accessing an Instant Messenger, the wireless slim terminal device comprising:
A) an input/output module for inputting or outputting command or data;
B) a short distance wireless communication module for establishing a short distance wireless connection with a wireless access point;
C) a communication control module for selecting a desired Instant Messenger, acquiring an instant message user identifier for the corresponding Instant Messenger, and transmitting the selected type of Instant Messenger and the corresponding instant message user identifier to the wireless access point through the short distance wireless communication module, and receiving a command and data from the input/output module and forwarding the command and data to the short distance wireless communication module for transmission to the wireless access point,
wherein the system enables the wireless slim terminal device to access an Instant Messenger through the wireless access point.
